(19) United States
(12) Patent Application Publication
(10) Pub. No.: US 2008/0047024 A1
(43) Pub. Date: Feb. 21, 2008

(54) Passive memory lock

(75) Inventors: Alexander Frank, Bellevue, WA (US); Isaac P. Ahdout, Bellevue, WA (US); William J. Westerinen, Sammamish, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/455,947

(22) Filed: Jun. 20, 2006

(51) Int. Cl. G06F 11/00

(52) U.S. Cl. 726/34

(57) ABSTRACT

To enforce contractual usage terms on an electronic device, such as a computer, a security function or circuit may consume all the devices processing power except enough to run a restoration program. The security function may provide problems or challenges for the processor to solve that are designed to consume all but a fraction of the processors compute power. Another embodiment occupies nearly all the device's system memory with a pattern and requires the device to respond to requests related to the memory contents. Both approaches place time limits on the response to help ensure the resource allocations are not being avoided. The security circuit may reset the computer when an incorrect or when no response is received within the time limit.

### BACKGROUND

Pay-as-you-go or pay-per-use business models have been used in many areas of commerce, from cellular telephones to commercial laundromats. In developing a pay-as-you go business, a provider, for example, a cellular telephone provider, offers the use of hardware (a cellular telephone) at a lower-than-market cost in exchange for a commitment to remain a subscriber to their network for a period of time. In this specific example, the customer receives a cellular phone for little or no money in exchange for signing a contract to become a subscriber for a given period of time. Over the course of the contract, the service provider recovers the cost of the hardware by charging the consumer for using the cellular phone.

The pay-as-you-go business model is predicated on the concept that the hardware provided has little or no value, or use, if disconnected from the service provider. To illustrate, should the subscriber mentioned above cease to pay his or her bill, the service provider deactivates the account, and while the cellular telephone may power up, calls cannot be made because the service provider will not allow them. The deactivated phone has no “salvage” value, because the phone will not work elsewhere and the component parts are not easily salvaged nor do they have a significant street value. In most cases, however, even though the phone has been deactivated it is still capable of connecting to the service provider in order to arrange restoration of the account. When the account is brought current, the service provider will reconnect the device to network and re-authorize calling.

This model works well when the service provider, or other entity taking the financial risk of providing subsidized hardware, is able to enforce the terms of the contract as above, that is, by limiting use of the device to only those functions required to restore the account. When the device is more complex, such as a computer, merely limiting access to a network may not be sufficient to force a subscriber to comply with terms of a contract.

### SUMMARY

The simplest, and possibly most effective, form of enforcement when a subscription or pay-per-use computer user fails to meet contractual obligations is to just disable or shut off the computer. However, such a measure may be difficult to recover from should the terms of the contract be satisfied. More desirable is an inexpensive, but highly tamper-resistant, mechanism for reducing the function of the computer to a such an extent that a restoration process is the only practical operation to perform.

A computer may be configured to enforce a locked operating mode using a simple, but effective, method of diverting such a high percentage of processor cycles or system memory, or both, to a special use so that operation of virtually any other useful user program or utility is unsustainable. In one embodiment, a security circuit ‘paints’ a substantial portion of system memory with a pattern and then requires the processor to make timed retrievals of specific memory locations, indicating the memory has not been reallocated, i.e. used by another program.

Another embodiment requires the processor to execute tasks that are calculated to occupy a significant portion of the processor's capability. Should the processor fail to reply with a correct response within a predetermined time, a logic circuit may cause a hard reset of the computer. The patterns painted into memory may be cryptographically generated. Another embodiment may require complex problems to be solved in a predetermined amount of time, the complexity of the problems and the amount of time allowed calculated to use all but a fraction of the computer's capability. Either approach, or a combination of the two, may be used to ensure that enough computing power is available to restore the system when allowed, but not enough to perform useful activities, such as document editing or gaming. Both approaches may involve cryptographic algorithms to allow a relatively small logic circuit to present either memory patterns or processor challenges, or a combination. In any event, the logic circuit must be able to generate the challenges and verify a correct response from the processor using a limited processing capability, relative to the overall resources of the computer.

### BRIEF DESCRIPTION OF THE DRAWINGS

FIG. 1 is a block diagram of a logical view of a computer;

FIG. 2 is a block diagram of an architecture of a computer similar to the computer of FIG. 1;

FIG. 2A is a block diagram of an alternate architecture of the computer of FIG. 2;

FIG. 3 is flow chart depicting an exemplary method of enforcing a limited function mode of operation in a computer;

FIG. 4 is flow chart depicting a second exemplary method of enforcing a limited function mode of operation in a computer;

FIG. 5 is a depiction of system memory with reserved space;

FIG. 6 is another depiction of system memory with reserved space; and

FIG. 7 is a representative block diagram of a secure execution environment.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

Many prior-art high-value computers, personal digital assistants, organizers, and the like, are not suitable for use in a pre-pay or pay-for-use business model as is. The ability to enforce a contract requires a service provider, or other enforcement entity, to be able to affect a device's operation even though the device may not be connected to the service provider, e.g. connected to the Internet. A first stage of enforcement may include a simple pop up warning, indicating the terms of the contract are nearing a critical point. A second stage of enforcement, for example, after pay-per-use minutes have expired or a subscription period has lapsed, may be to present a system modal user interface for adding value and restoring service. A provider's ultimate leverage for enforcing the terms of a subscription or pay-as-you go agreement is to disable the device. Such a dramatic step may be appropriate when it appears that the user has made a deliberate attempt to subvert the metering or other security systems active in the device.

Uses for the ability to place an electronic device into a limited function mode may extend beyond subscription and pay-per-use applications. For example, techniques for capacity consumption could be used for operating system licensing enforcement. Other applications may use multiple levels of performance limiting, based on the expected foreground task. For example, a test administration application may use one level of enforcement during the test and a second level of enforcement while the scores are being processed.

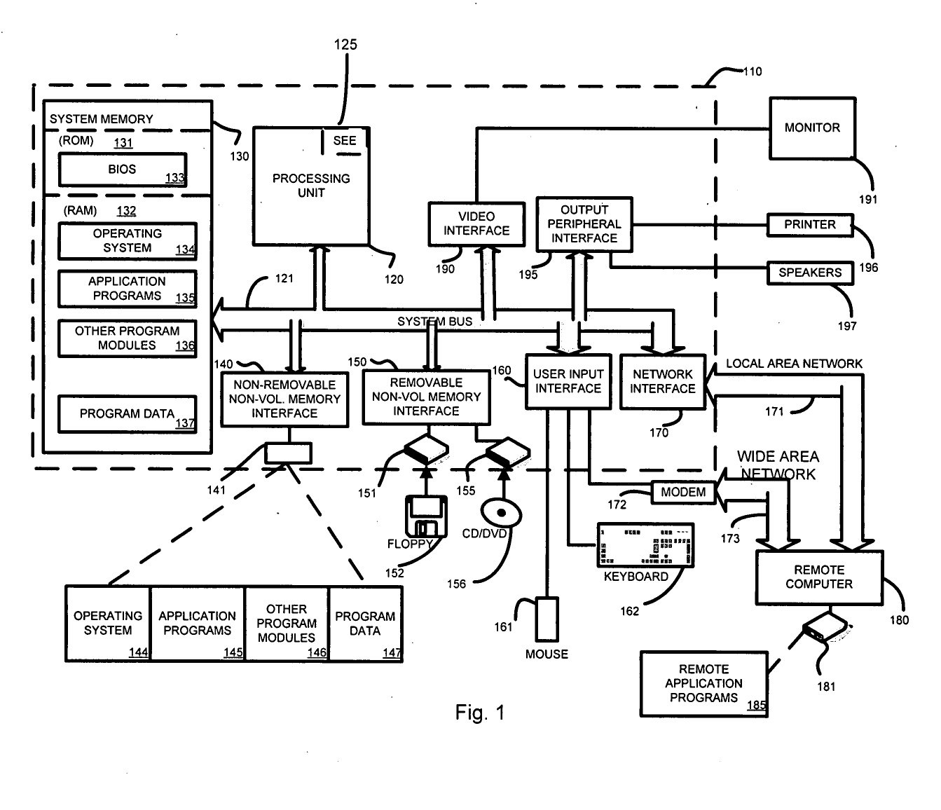

FIG. 1 illustrates a logical view of a computing device in the form of a computer 110 that may be connected to a network, such as local area network 171 or wide area network 173 and used in a pay-per-use or subscription mode. For the sake of illustration, the computer 110 is used to illustrate the principles of the instant disclosure. However, such principles apply equally to other electronic devices, such as those mentioned above. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 may include a secure execution environment 125 (SEE). The SEE 125 may be enabled to perform security monitoring, pay-per-use and subscription usage management, and policy enforcement related to terms and conditions associated with paid use, particularly in a subsidized purchase business model. The secure execution environment 125 may be embodied in the processing unit 120, as a standalone component, or as part of another circuit, as depicted in later figures.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 10, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 10 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

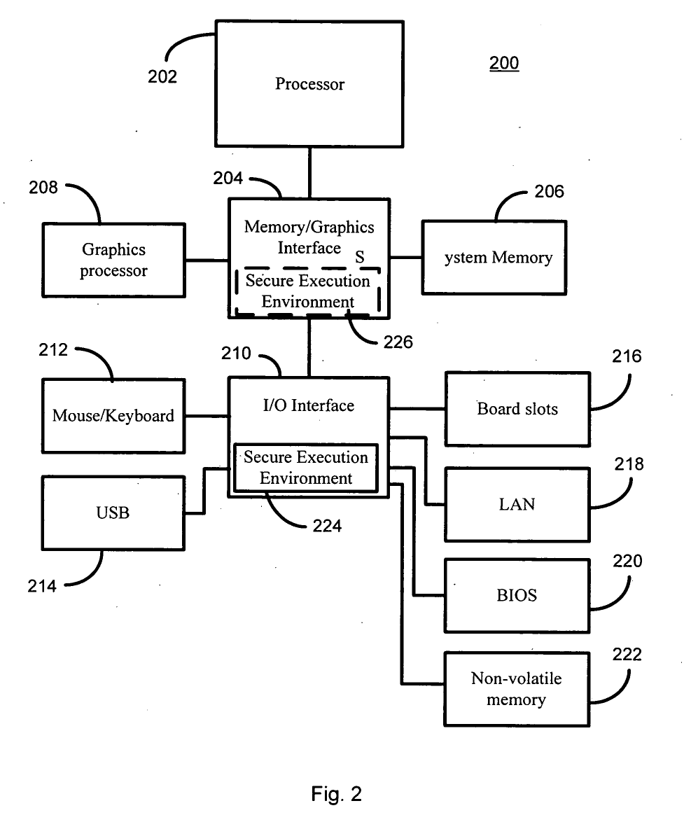

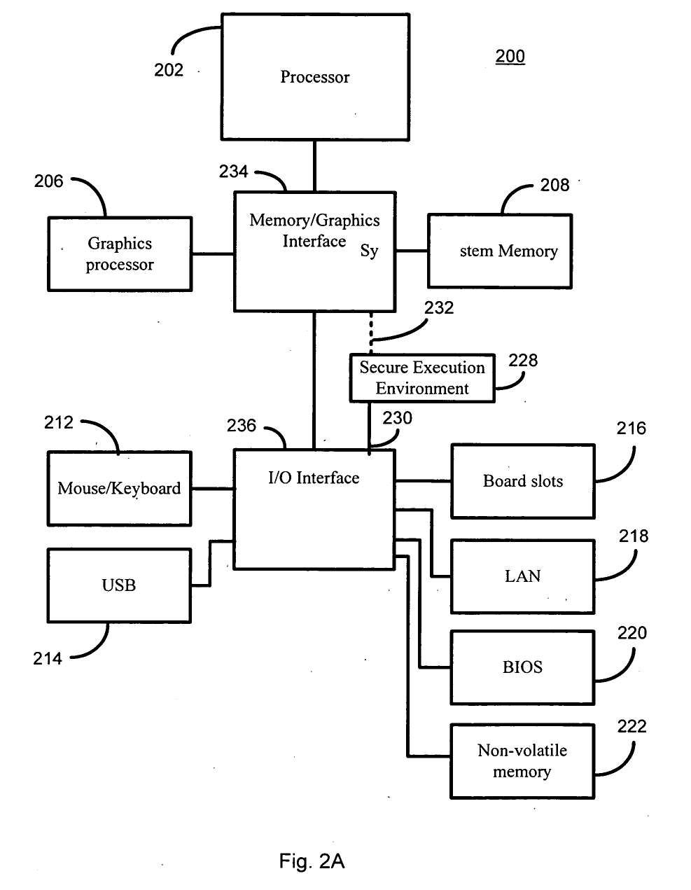

FIG. 2 is an architectural diagram of a computer 200, the same as or similar to the computer of FIG. 1. The architecture of the computer 200 of FIG. 2 may be typical of general-purpose computers widely sold and in current use. A processor 202 may be coupled to a graphics and memory interface 204. The graphics and memory interface 204 may be a “Northbridge” controller or its functional replacement in newer architectures, such as a “Graphics and AGP Memory Controller Hub” (GMCH). The graphics and memory interface 204 may be coupled to the processor 202 via a high speed data bus, such as the “Front Side Bus” (FSB), known in computer architectures. The processor 202 may also be connected, either directly or through the graphics and memory interface 204, to an input/output interface 210 (I/O interface). The I/O interface 210 may be coupled to a variety of devices represented by, but not limited to, the components discussed below. The I/O interface 210 may be a “Southbridge” chip or a functionally similar circuit, such as an “I/O Controller Hub” (ICH). Several vendors produce current-art Northbridge and Southbridge circuits and their functional equivalents, including Intel Corporation.

A variety of functional circuits may be coupled to either the graphics and memory interface 204 or the I/O Interface 210. The graphics and memory interface 204 may be coupled to system memory 206 and a graphics processor 208, which may itself be connected to a display (not depicted). A mouse/keyboard 212 may be coupled to the I/O interface 210. A universal serial bus (USB) 214 may be used to interface external peripherals including flash memory, cameras, network adapters, etc. (not depicted). Board slots 216 may accommodate any number of plug-in devices, known and common in the industry. A local area network interface (LAN) 218, such as an Ethernet board may be connected to the I/O interface 210. Firmware, such as a basic input output system (BIOS) 220 may be accessed via the I/O interface 210. Nonvolatile memory 222, such as a hard disk drive or any of the other non-volatile memories listed above, may also be coupled to the I/O interface 210.

A secure execution environment (SEE) 224 is shown disposed in the I/O interface 210. An alternate embodiment shows another secure execution environment 226 disposed in the graphics and memory interface 204. While system configurations with more than one secure execution environment are supported, one exemplary embodiment is directed to a single instance of the secure execution environment.

FIG. 2A is an alternate embodiment of the computer of FIG. 2. In this embodiment, a secure execution environment 228 is not disposed in one of the interface circuits 234 and 236, but is a separate unit. The secure execution environment 228 may be coupled to the I/O interface 236 by bus 230. Similarly, when configured with the graphics and memory interface 234, the secure execution environment 228 may be coupled to the graphics and memory interface 234 via bus 232. The separate busses 230 and 232 may be used so as not to interfere with the very high data rates between the processor 202, the graphics and memory controller 234, and the I/O interface 236. A lower speed bus may satisfy the requirements of such an implementation, for example, an inter-integrated circuit bus (IIC or I²C), known in the art.

Because the SEE may be part of the processor 120, as shown in FIG. 1, part of a support chip, as shown in FIG. 2, or standalone circuit as shown in FIG. 2A, the different capabilities of the various implementations allow varying levels of sophistication in execution. A secure execution environment 125, located inside the processing unit 120, has access to virtually all the functions of the computer 110, or other electronic device. Memory limitations may be imposed, the instruction set may be reduced, processing speed may be restricted, etc. Further, because the SEE 125 is embedded in the processor it is virtually immune to hardware attacks and hardened against software attacks. However, embedding a secure execution environment inside a commercial processor may be both time-consuming and costly.

When the secure execution environment is embedded in the graphics and memory interface 204 or the I/O interface 210, as in FIG. 2, there is not quite as much flexibility at the command of the respective secure execution environments 226 224. Graphics and memory interface 204 allows control over system memory 206, the graphics processor 208, and data passing to and from the I/O interface 210. Memory restrictions, reduced graphics output, and restrictions on network access are a few sanctions available to an interface chip based secure execution environments. As above, embedding a secure execution environment in either a Northbridge or Southbridge chip may be time-consuming and expensive and subject to frequent updates as interface circuits change across generations of architectures.

As discussed with respect to FIG. 2A, a secure execution environment 228 may be separately packaged and placed in communication with the remaining functional elements of the computer through either a standard I/O interface, or through a dedicated bus, such as depicted by interfaces 230 and 232. Because of the relative ease of implementation, this outboard approach may be useful when more sophisticated implementations, such as those described above, are not available. Because the outboard circuitry is more susceptible to attack, the SEE 228 may be implemented in simple logic and have more or different functions from the SEE embodiments described above. Unlike embedded implementations, an outboard approach may not have at its disposal access to critical circuitry and its ultimate ability to enforce may be limited to resetting or powering off the computer. Because frequent, periodic, resets or power cycling may interfere with recovery processing, such a brute force strategy may be reserved for the most difficult situations, such as blatant hacking.

The technique referenced above, resource diversion, may be used to restrict processing power available to a user while still allowing recovery processes to be run, without imposing arbitrary time limits to the recovery process.

Two basic approaches may be used to divert resources, as well as combinations of these two. One basic approach is to require the processor to perform tasks that consume nearly all its resources. The second basic approach is to occupy all but a small fraction of system memory so that only small, simplistic programs can run in the unoccupied memory space. Both approaches and the combinations available are suitable for use by any of the SEE embodiments of FIGS. 1, 2, or 2A, but a strength of the approach is found when the SEE 228 is implemented in an outboard chip or logic circuitry as shown in FIG. 2A. Other implementations may have more sophisticated methods of enforcement, or may have a direct ability to limit the functionality of the computer or other electronic device. The resource diversion technique is well suited to implementations where the only true enforcement mechanism is a so-called “big stick,” such as causing a system reset.

The resource diversion technique also is applicable when the limited function mode is recognized by the processor at start up and is ‘cooperative,’ or when the processor merely responds to high priority processes requesting tasks to be performed. In being cooperative, the processor may recognize that a special case (the limited function mode) is executing and automatically gives priority to the resource diversion tasks, but such cooperation is not required.

A lower bound may be determined for the resources consumed by a particular challenge or task. That is, for a known electronic device configuration, e.g. processor type and speed, memory size and speed, etc., a given task may require 40 milliseconds of 95% of all processor cycles to calculate a result. Similarly, when the task corresponds to retrieving data from memory, 10,000 data fetches with consecutive hash functions may require 250 milliseconds. When the lower bound, that is, a theoretical minimum compute time/resource usage combination, is known, the limits set for a response can be set such that all the resources required for useful computing are consumed but yet enough processing power is available for performing a restoration function either through the user interface or at a network service site.

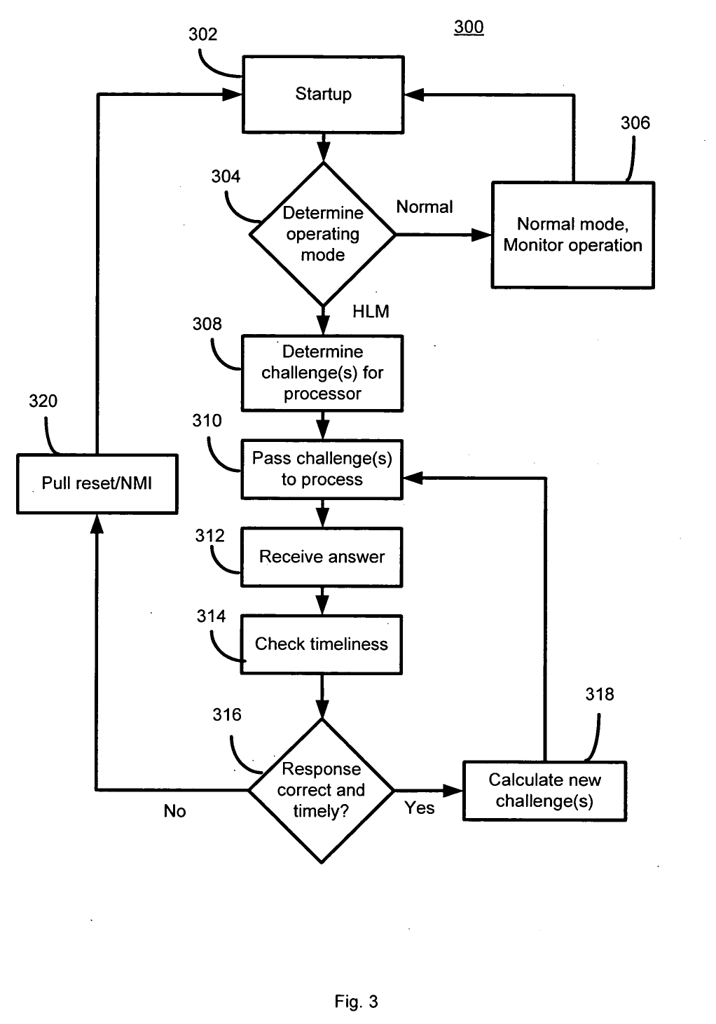

Referring to FIG. 3, an exemplary method of diverting resources using the first basic approach, that is, processor-oriented tasks, is discussed and described. At block 302, a computer, such as computer 200, may be started and at block 304 a determination made whether the computer 200 is in a normal operating mode or a hardware lock mode (HLM). The embodiment discussed assumes a reset accompanies entry to the HLM, but in other embodiments HLM may be entered directly.

When the computer 200 is operating in normal mode, the ‘normal’ branch may be followed to block 306 and the computer operated in a normal mode until next startup at block 302. In one embodiment, any condition that would cause the computer 200 to leave the normal mode, such as detection of tampering, or expiration of usage minutes, may cause a reset enforce operation to continue at block 302. In another embodiment, a function of the normal operating mode may be to periodically check operating status for a mode change at block 304, such as once per minute.

If, at block 304, it is determined that the computer 200 is in an HLM mode, the branch ‘HLM’ may be followed to block 308. The secure execution environment 228 may determine a set of challenges to present to the processor to block resources from other user tasks. The SEE 228 may have significantly less processing power than the processor 202 of computer 200. Therefore, the ideal challenge should be easy for the SEE 228 to calculate and present, but difficult for the processor 202 to calculate and answer. Also, the challenge must be tuned to the particular system configuration of computer 200, accounting for, among other things, processor speed and capability as well as internal bus speeds so that the challenge may consume the desired amount of resources while leaving enough processing capability for system restoration.

A cryptographic calculation lends itself to such criteria. For example, a DES algorithm is both compact and fast, allowing the SEE 228 to process a cryptographic result in a very short amount of time even with a limited processing capability, or in even less time with a hardware accelerator or dedicated cryptographic processor. A challenge may be calculated at block 308, using clear text to generate a corresponding cipher text using a key known only to the SEE 228. While challenges other than cryptographic challenges may be equally effective, one embodiment uses the DES algorithm because it has been so widely characterized and optimized algorithms relating to DES encryption, decryption, and cracking are widely available. The challenge, then, is for the processor 202 to take the clear text and the cipher text and return the value of the key.

At block 310, the clear text and cipher text may be presented to the processor 202, and a timer may be started inside the SEE 228. Because brute force cracking of a DES key is a statistical process, that is, a truly random key may be anywhere in the key search space. Correspondingly, trying each key in the search space may result in relatively short or relatively long key search times. To account for this, rather than use a single challenge, the SEE 228 may present hundreds, or even thousands, of clear text-cipher text pairs for cracking. Given a reasonable level of randomness, the average solution time over all the pairs will approach 50% of the theoretical maximum.

Part of the tuning process to accommodate differences in speed and architecture may be to use shorter keys than would normally be used in a typical cryptographic operation, such as 24 bits instead of 64 or 128 bits. Similarly, the fastest known cracking algorithm may be given to the processor for use in cracking keys so that the SEE 228 can better approximate the expected result time. Since some algorithms may already be optimized to certain key sizes, such as 64-bit or 128 bit, the SEE 228 may provide the processor 202 with information regarding limits on where the keys may be found, or by passing a known number of key bits to the processor 202 to limit the key search space. Similarly, limiting the key size or key search space may allow finer tuning of the resource usage.

Another consideration for presenting and receiving challenges and results may be the bandwidth of the connection between the SEE 228 and the other components of the computer 200. For example, connections 230 and 232 may use the single bit SPI bus for very low transfer rate. Thus receiving thousands of results from the key cracking process may unduly burden the connection. A further challenge can be for the processor 202 to perform some additional processing, such as hashing all the key results in providing only the hash the SEE 228. Again, hashing algorithms are fast and well known and would allow the SEE 228 to quickly calculate and store an expected result during the processing at block 312, to quickly determine the accuracy of the answer.

At block 314, the timeliness of the result may be compared to an expected time for the known algorithms to calculate key values for the given challenges. At block 316, a determination may be made regarding the response accuracy and timeliness. When the results provided by the processor 202 are timely and correct, the ‘yes’ branch may be followed to block 318 and a new set of challenges calculated for use at block 310 to repeat the process. When, at block 316, the result is not correct or not provided in a timely fashion the ‘no’ branch may be followed to block 320. When the results are not correct or the answer is not provided in a timely fashion, the SEE 228 must assume that the processor 202 was not fully dedicated to responding to the challenge presented and that other processes were running or being attempted. Therefore at block 320, a reset, non-maskable interrupt (NMI), or power interruption may be triggered causing a reset to occur. If other processing resources are available in the system, for example, a graphics processor, other system peripheral, or even a cryptographic processor, the challenges may have to be adjusted for the sum-total of the accessible resources. Particularly in the case of a cryptographic co-processor, such as plug-in boards, additional challenges may be generated requiring simultaneous computations to maintain the desired level of resource diversion. As long as the resources can be identified, either at the time of manufacture or on-the-fly, and their processing capabilities known, the technique can be effectively implement.

In order to manage HLM mode processing, when the computer 200 comes out of reset and is determined to be in HLM mode, execution priorities must be set to guarantee that the process responding to challenges has a higher priority than other user-initiated tasks so that the challenges may be processed on schedule. Also, the ideal challenge set should be solvable in a fairly short amount of time with respect to network round-trip times, so the processor does not simply offload the calculations to a remote processor.

When trying to hack key values and multiple challenges are presented, a technique known as bit slicing may be employed to try a given key value for each of the challenges presented, saving time over running through each key for each challenge. To address this technique, the keys may designed to be non-overlapping, or the allocated time may be adjusted with the assumption bit-slicing will be employed.

The SEE 228 may be given the hardware configuration of the computer at the time of manufacture so that it can correctly calculate the challenges to consume the desired amount of processing capability. The SEE 228 may also require access to a known service to periodically determine whether the algorithms used are still valid. For example, over the course of time a significantly better DES algorithm may be discovered that would render the challenge generating algorithm useless for the task of diverting resources. If that should happen, a new algorithm may be downloaded, new key lengths set, or new response times set in order to restore the effectiveness of the process.

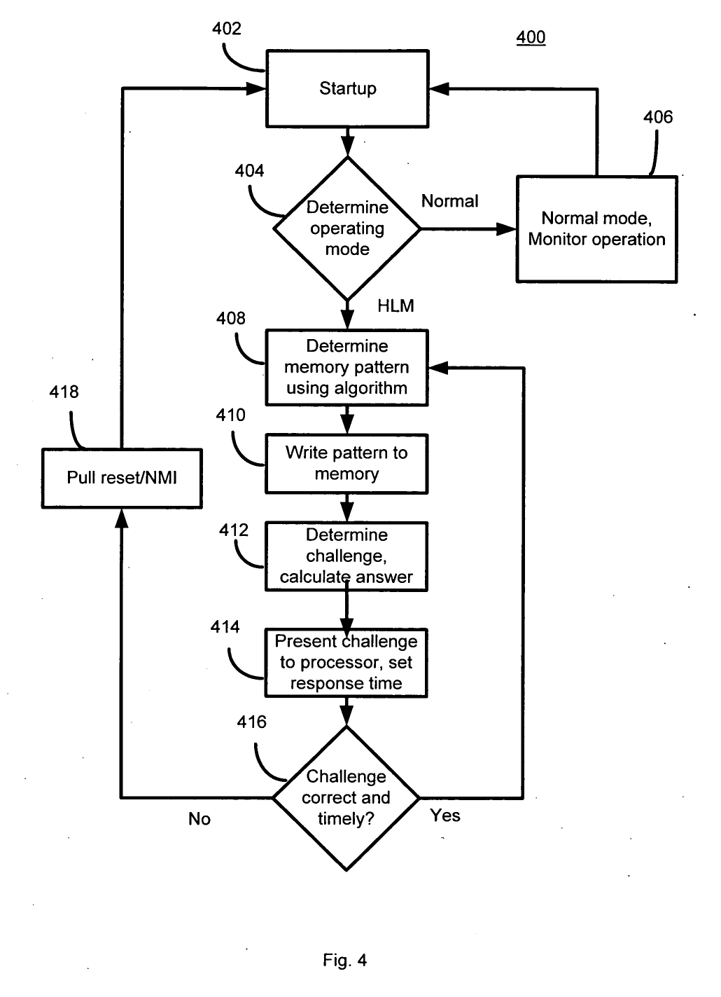

FIG. 4 is a method of implementing the second basic approach to resource diversion. To reiterate, this second basic approach involves consuming substantially all the system memory so that only rudimentary programs associated with restoring the computer 200 to normal operation are practically supported. As with the method of FIG. 3, the assumption is made that the computer 200 starts from a reset at block 402, although other embodiments are possible. At block 404, the mode may be determined.

When in a normal operation mode, the ‘normal’ branch from block 404 may be taken to block 406. Normal operation continues and the SEE 228 may function normally to monitor operations including performing metering, when required. In one embodiment, any condition that would cause the computer 200 to leave the normal mode, such as detection of tampering, or expiration of usage minutes, may cause a reset enforce operation to continue at block 402. In another embodiment, a function of the normal operating mode may be to periodically check operating status for a mode change at block 404, such as once per minute.

When in a hardware locked mode, the ‘HLM’ branch from block 404 may be taken to block 408, where a memory pattern may be determined, for example, using an algorithm.

In a trivial embodiment, the SEE 228 would have the same amount of memory as the system memory 208. The SEE 228 could generate a pattern of any nature and transfer its memory to the system memory 208 minus a small amount, such as a 1 MB. Because it is not uncommon for system memory 208 to have 1 GB or more memory, it is impractical for the SEE 228 to have an identical amount of memory. As above, a cryptographic algorithm may be useful in generating a pattern to place into the system memory 208. In one embodiment, the SEE 228 can use a simple, fast algorithm, such as DES or AES, and use a key seed value to calculate memory values. In one embodiment, the memory location address itself can be encrypted to produce the value stored in that memory location. At block 410 the pattern may be written to system memory 208. The algorithm may be implemented in software, firmware, or hardware.

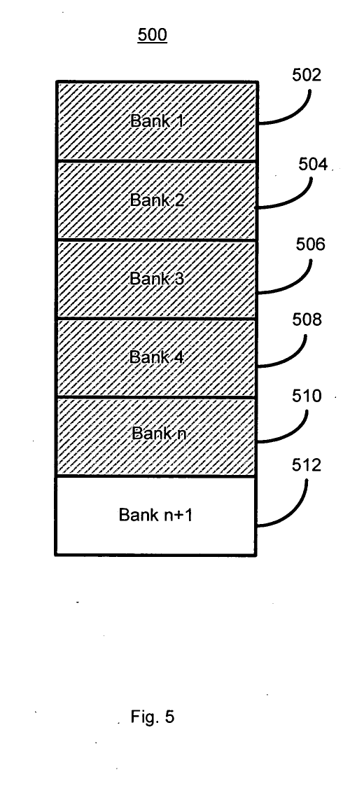

Referring briefly to FIG. 5, a representative system memory 500 is shown divided into a number of banks, for example 4 kB banks. Bank 1 502 to bank n 510 are shown as as being completely occupied with the pattern generated by the SEE 228. Only bank n+1 512 is available for general use by the processor. Returning to FIG. 4, a problem is to ensure that the pattern remains in memory and that it is not diverted to general use. To accomplish this, at block 412, the SEE 228 may determine a challenge to present to the processor related to contents of the system memory 208. In one embodiment, the answer may be calculated at the same time as the challenge, however in other embodiments the answer may be calculated after the receipt of a response from the processor 202. Deferring the calculation of the answer prevents the SEE 228 from expending resources calculating answers to challenges that are not responded to in a timely manner.

At block 414 the challenge may be presented to the processor 202 and a timer started or an expected response time noted. The goal of the challenge is to make the processor 202 prove to the SEE 228 that the system memory is occupied by the pattern. The challenge may simply be to return the value of a given memory location in such a short period of time as to not allow a disk access or access to an external memory such as a thumb drive. Because system memory 208 is typically at least an order of magnitude faster than any other large memory, the timing goals may be relatively loose and still accomplish the desired result.

When a response is received, an evaluation may be made at block 416 to determine if the challenge response is correct and timely. Alternatively, if the allotted time period expires and no response is received, it may be counted as an incorrect response. When the response is untimely or incorrect, the ‘no’ branch from block 416 may be taken to block 418 and a reset may be triggered or other dramatic action imposed, such as interrupting power to the computer 200.

If the response is correct and timely the ‘yes’ branch from block 416 may be taken, in this embodiment, to block 408 and a new challenge calculated and the resource diversion process repeated.

The use of an algorithm to generate memory location values optimizes the SEE's 228 limited memory size. Another optimization may be made recognizing the SEE's 228 disadvantage in processing power over the main processor 202. The SEE 228 may not be able to calculate values for every location as fast as the processor 202 could respond to requests to provide a value for that memory location. The SEE 228 may ask for a high number of responses, for example 1000, but may only check a handful, such as 100. Because the processor does not know which results will actually be asked for and checked, the processor must maintain the generated values in all the designated memory locations.

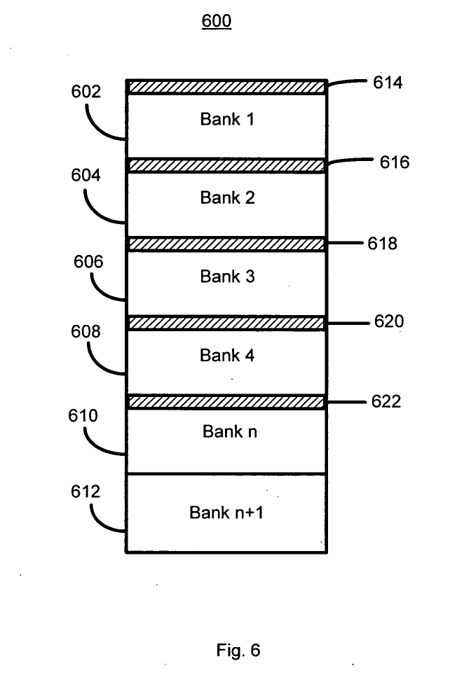

Another optimization may be required to overcome limited bandwidth connecting the SEE 228 to the rest of the computer 200. As mentioned above, the bandwidth of such a connection may be in a kilobyte per second range compared to processor and front side bus of potentially gigabytes per second. If the SEE 228 were to calculate and provide discrete values for every memory location in the system memory 208, the process could take hours to complete. To overcome this, the SEE 228 may provide an algorithm and parameters for the processor to populate the desired memory locations itself. This works as long as the algorithm is expensive with respect to calculation time compared to reading a memory location, that is, the algorithm used to calculate a memory location value should take significantly longer to execute than to read the memory location and provide the response. Thus the system memory cannot be diverted to other tasks while the processor is relied upon to calculate responses to memory location requests from the SEE 228 in real time. Referring briefly to FIG. 6, another accommodation to both bandwidth and processing limitations of the SEE 228 may be illustrated. An exemplary system memory 600 is shown having banks 1 to n+1, 602, 604, 606, 608, 610, 612 respectively. In this embodiment, a slice of each memory bank 614, 616, 618, 620, 622 is taken from each of the respective banks of memory, except bank n+1 612, which is to remain available for general use. Because most memory management systems manage in banks, requiring even a small portion of each Bank to be dedicated to responding to challenges from the SEE 228 eliminates practical use of that bank by other programs. Because only a fraction of the memory locations require specific values, the requirements of processing overhead of the SEE 228 and the bandwidth connecting the SEE 228 are greatly reduced.

To further accommodate bandwidth restrictions to the SEE 228, the challenge may further include some post-processing on multiple memory location results before providing an ultimate response to the SEE 228. For example, values from 500 memory locations may be retrieved and hashed, or consecutively encrypted, before returning a single result to the SEE 228.

In some systems, memory in a graphics processor 206, external memory, or future peripheral (not depicted) may be substantially as fast as system memory 208 and as plentiful. If access to the graphics processor 206 memory or other memory is known, the additional memory may simply be added to memory captured by the SEE 228 for overwriting. When the access characteristics are similar to, but not exactly the same as the main system memory, timing characteristics may be stored in the SEE 228 and appropriate adjustments made for response times from those portions of memory. Thus, slower memory or even mapped memory may be captured by the SEE 228 using custom timings. Other attempts to circumvent the HLM mode using this technique for protection may be to increase the system memory 208 size or to increase the speed or computing power of the processor 202. In some cases, the SEE 228 may be able to determine system memory size and or control it to a fixed setting as well as determine processor capability. When such capabilities are not available, the memory size and processor capability may simply have to be fixed during the manufacturing process either through BIOS changes or by simple mechanical methods such as potting the memory.

A combination of processes that both paints memory and presents problems to the computer is a simple extension of the alternatives described above. For example, certain system memory 208 locations may store clear text-ciphertext pairs that are known only to the SEE 228 and are used in timed processor challenges.

In either case, such an approach allows substantially disabling a computer, or other electronic device, using relatively lightweight processing power in a circuit, or function, whose only recourse is a reset. As long as the computer complies with the requests, i.e. challenges, presented to it, the computer may run indefinitely, allowing simple diagnostics and restoration processes to be performed. The technique may be hardened against software attacks, making it difficult to deliver widespread attacks over the Internet. Without a simple software attack available, a hacker would be required to remove the cover and physically alter the system to defeat the protection circuitry. The resource diversion techniques described herein are both efficient and inexpensive to implement, especially when compared to techniques requiring chip redesigns to accommodate an embedded secure execution environment.

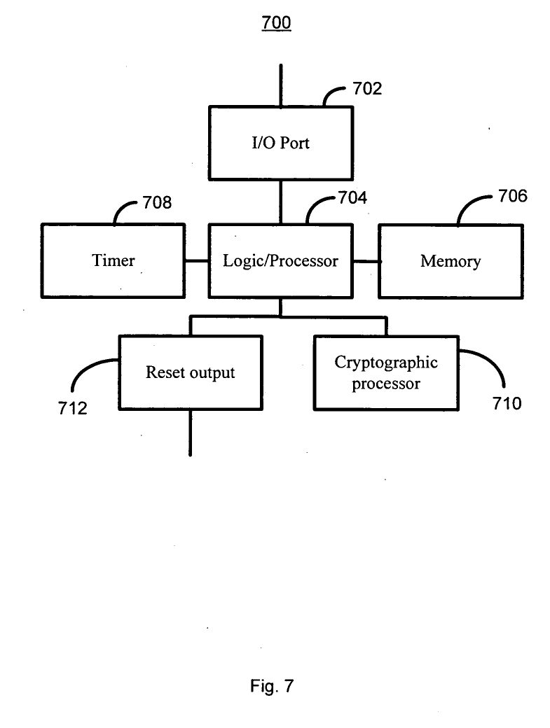

FIG. 7, a block diagram of a representative secure execution environment 700 is discussed and described. And I/O port 702 a couple the secure execution environment 700 with one or more functional circuits inside a computer, such as, computer 200 of FIG. 2A. The I/O port 700 to may be coupled to a logic unit or processor 704. The processor 700 for may have access to memory 706 and a timer 708. The memory 706 may ideally be secured from tampering and be used for storing cryptographic keys as well as expected results from challenges sent to the computer 200, as discussed above. The timer 708 should also be tamper-resistant and able to provide reliable time, or at least reliable clicks so that the processor 704 may determine whether responses are received in a timely manner. The processor 704 may also be coupled to a cryptographic processor 710 for use in executing specific cryptographic functions that may be impractical for the processor 704 to calculate in a timely fashion. Finally, a reset output 712 may be provided for triggering the computer 200 into a reset one the results provided by the computer 200 and are incorrect or are not timely, as also discussed above. The secure execution environment may be a custom or semi custom application-specific integrated circuit (ASIC) or may be a smart chip, such as one available from Infineon Corporation or other smart chip manufacturers.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A computer adapted for operation in an unrestricted use mode and a limited use mode comprising:
a processor; and
a logic circuit coupled to the processor comprising:
a port for sending a challenge to the processor when the computer is in the limited use mode and for receiving a response corresponding to the challenge;
a computational circuit for determining when the response is correct; and
an output for causing a disruption in operation of the computer when the response is incorrect.

2. The computer of claim 1, further comprising a memory, wherein the computational circuit generates a pattern to store in the memory and the challenge corresponds to the pattern.

3. The computer of claim 2, wherein the pattern is stored in substantially all the memory.

4. The computer of claim 2, wherein the pattern is stored in a portion of substantially each page of the memory.

5. The computer of claim 2, wherein the logic circuit passes parameters to the processor and the processor uses the parameters to generate the pattern.

6. The computer of claim 1, wherein the logic circuit further comprises a timer for determining whether the response to the challenge is received within a predetermined period, wherein the output causes the disruption in operation when the correct response is not received during the predetermined period.

7. The computer of claim 6, wherein the challenge is calculated to consume at least a predetermined percentage of the processor capacity during the predetermined period.

8. The computer of claim 1, wherein the logic circuit comprises a cryptographic function for determining the challenge and when the response is correct.

9. The computer of claim 1, wherein preparing the response requires substantially all the processing power of the processor.

10. A method of enforcing a limited function mode in an electronic device comprising:
determining a task for the electronic device to execute, the task having a known lower bound on resource utilization;
presenting the task for execution when a limited function mode is prescribed for the electronic device;
receiving a result from execution of the task;
presenting a new task when the result is acceptable; and
disabling the computer, at least temporarily, when the result is unacceptable.

11. The method of claim 10, wherein determining the task comprises developing a set of cipher texts and corresponding key ranges and wherein presenting the task to the electronic device comprises requiring the electronic device to find a key in the key range for deciphering each respective cipher text in the set.

12. The method of claim 10, wherein determining the task comprises determining a data pattern and wherein presenting the task to the electronic device comprises writing the data pattern to memory and requiring the electronic device to execute a function corresponding to the data pattern in memory.

13. The method of claim 12, wherein the known lower bound on resource utilization when executing the function corresponds to consuming a predetermined portion of the processor's capacity.

14. The method of claim 12, wherein determining the data pattern comprises calculating a cryptographic result using a cryptographic algorithm and a seed value.

15. The method of claim 12, wherein writing the data pattern to the memory comprises writing the data pattern to a contiguous block of memory comprising at least 95% of the generally available memory.

16. The method of claim 12, wherein executing the function corresponding to the data pattern comprises processing the task at any processing resource of the computer with known capabilities, the processing resource comprising a system processor, a graphics processor, a cryptographic processor, and a system co-processor.

17. The method of claim 10, wherein the disabling the electronic device when the result is unacceptable comprises causing one of a system reset and a power cycle when the result is unacceptable.

18. The method of claim 10, wherein determining if the result is acceptable comprises verifying the correctness of the result and determining if the result is provided within a predetermined period of time.

19. A logic circuit for use in a computer having a processor and adapted to operate in a limited function mode, the logic circuit comprising:
a cryptographic function for calculating a memory pattern and an expected result to a challenge;
a timer for determining a time period for a response to the challenge;
a first circuit for presenting the memory pattern and the challenge to the processor in the computer, wherein the first circuit receives the response from the processor and when the result is outside the time period for a response or the result does not match the expected result, the first circuit disables the computer, at least temporarily.

20. The logic circuit of claim 19, wherein the cryptographic function uses a cryptographic algorithm to calculate the memory pattern using a key known only to the logic circuit, wherein the challenge corresponds to determining the key.
